(19) United States
(12) Patent Application Publication
(10) Pub. No.: US 2013/0218724 A1
(43) Pub. Date: Aug. 22, 2013

(54) VEHICLE OWNERSHIP IMPACT EVALUATION

(71) Applicants: Brunno L. Moretti, Walled Lake, MI (US); Kyle Holihan, South Lyon, MI (US); Jonathan K. Williams, Belleville, MI (US)

(72) Inventors: Brunno L. Moretti, Walled Lake, MI (US); Kyle Holihan, South Lyon, MI (US); Jonathan K. Williams, Belleville, MI (US)

(73) Assignee: GM GLOBAL TECHNOLOGY OPERATIONS LLC, Detroit, MI (US)

(21) Appl. No.: 13/400,733

(22) Filed: Feb. 21, 2012

(51) Int. Cl. G06Q 30/00

(52) U.S. Cl. 705/26.63

(57) ABSTRACT

Vehicle ownership impact evaluations are implemented by a host system having logic executable thereon. The logic calculates mileage indicative of a roundtrip for a commute received from a user. The logic also acquires terrain data for the commute from a database containing topological information. The logic uses the routing information, in conjunction with a timestamp associated with input from the user, to access a database containing climate information for a geography identified from the routing information, and determines an estimated climate for a time of year via the timestamp. The logic receives an identifier for a vehicle from the user, and retrieves specification data for the vehicle via the identifier. The logic further applies the specification data to the mileage, the estimated climate, the terrain data, and a base energy price, and calculates estimated costs for the commute in terms of energy consumed for the round trip by the vehicle.

### FIELD OF THE INVENTION

The subject invention relates to data processing, and more particularly, to evaluation of vehicle ownership impact.

### BACKGROUND

Vehicle dealerships strive to offer their potential customers accurate information on various aspects of a vehicle of interest, such as costs of operation and possible savings. However, with the vast number of attributes or preferences from which a customer may select to compare against two or more vehicles, and due to the extensive differences among the many makes and models of vehicles on the market, providing consumers with concise and easy-to-understand information can be very burdensome.

One type of information provided for consumers is an Environmental Protection Agency (EPA) sticker that is placed on a vehicle at the dealership and provides fuel economy estimates for that particular vehicle. Information may also be provided in marketing materials or on a dealer's or manufacturer's website. However, the consumer must individually access separate websites or pages for each vehicle of interest, and much of this information is presented disjointedly or in a format that makes side-by-side comparisons difficult. In addition, the information that is provided to consumers is not customized or tailored to the consumers' unique needs or circumstances, nor is the information provided in a way that allows the consumers to compare detailed attributes of two or more vehicles within a single web page or document.

Accordingly, it is desirable to provide a way for consumers to access detailed vehicle information that is customized to the consumers' unique needs or circumstances and which allows the consumers to compare like attributes among two or more vehicles from a single source.

### SUMMARY OF THE INVENTION

In one exemplary embodiment of the invention, a system for implementing vehicle ownership impact evaluations is provided. The system includes a host system computer, and logic executable by the host system computer. The logic is configured to implement a method. The method includes calculating a mileage value indicative of a round trip for a commute using a start address and an end address that are received from a user, the start address and the end address collectively specifying commute data for the commute; accessing a database containing topographical information using routing information derived from the commute data, and acquiring terrain data for the commute; using the routing information in conjunction with a timestamp associated with input received from the user, accessing a database containing climate information for a geography identified from the routing information, and determining an estimated climate for a time of year via the timestamp; receiving, from the user, an identifier for a first vehicle; accessing a specification database and retrieving specification data for the first vehicle via the identifier, the specification data including capabilities, performance characteristics, and specifications of the first vehicle; applying the specification data for the first vehicle to the mileage value, the estimated climate, the terrain data, and a base energy price; and calculating estimated costs for the commute in terms of energy consumed for the round trip by the first vehicle, the estimated costs being a function of the mileage, the estimated climate, the terrain data, and the base energy price.

In another exemplary embodiment of the invention, a method for implementing vehicle ownership impact evaluations is provided. The method includes calculating a mileage value indicative of a round trip for a commute using a start address and an end address that are received from a user, the start address and the end address collectively specifying commute data for the commute; accessing a database containing topographical information using routing information derived from the commute data, and acquiring terrain data for the commute; using the routing information in conjunction with a timestamp associated with input received from the user, accessing a database containing climate information for a geography identified from the routing information, and determining an estimated climate for a time of year via the timestamp; receiving, from the user, an identifier for a first vehicle; accessing a specification database and retrieving specification data for the first vehicle via the identifier, the specification data including capabilities, performance characteristics, and specifications of the first vehicle; applying the specification data for the first vehicle to the mileage value, the estimated climate, the terrain data, and a base energy price; and calculating estimated costs for the commute in terms of energy consumed for the round trip by the first vehicle, the estimated costs being a function of the mileage, the estimated climate, the terrain data, and the base energy price.

In yet another exemplary embodiment of the invention a computer program product for implementing vehicle ownership impact evaluations is provided. The computer program product includes a computer-readable storage medium having instructions embodied thereon, which when executed by a computer, cause the computer to implement a method. The method includes calculating a mileage value indicative of a round trip for a commute using a start address and an end address that are received from a user, the start address and the end address collectively specifying commute data for the commute; accessing a database containing topographical information using routing information derived from the commute data, and acquiring terrain data for the commute; using the routing information in conjunction with a timestamp associated with input received from the user, accessing a database containing climate information for a geography identified from the routing information, and determining an estimated climate for a time of year via the timestamp; receiving, from the user, an identifier for a first vehicle; accessing a specification database and retrieving specification data for the first vehicle via the identifier, the specification data including capabilities, performance characteristics, and specifications of the first vehicle; applying the specification data for the first vehicle to the mileage value, the estimated climate, the terrain data, and a base energy price; and calculating estimated costs for the commute in terms of energy consumed for the round trip by the first vehicle, the estimated costs being a function of the mileage, the estimated climate, the terrain data, and the base energy price.

The above features and advantages and other features and advantages of the invention are readily apparent from the following detailed description of the invention when taken in connection with the accompanying drawings.

A summary needs to be added to address a web page based analysis (program accessed on remote server).

### BRIEF DESCRIPTION OF THE DRAWINGS

Other features, advantages and details appear, by way of example only, in the following detailed description of embodiments, the detailed description referring to the drawings in which:

FIG. 1 is a system upon which vehicle ownership impact evaluations may be implemented in accordance with an exemplary embodiment of the invention;

FIG. 2 is a flow diagram describing a process for implementing vehicle ownership impact evaluations in accordance with an exemplary embodiment;

FIG. 3 is a user interface screen for providing input data used in calculating vehicle ownership impact costs in accordance with an exemplary embodiment of the invention; and

FIG. 4 is a table providing sample output produced by a vehicle ownership impact evaluation in accordance with an exemplary embodiment.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

In accordance with an exemplary embodiment of the invention, vehicle ownership impact evaluation services (also referred to herein as “impact evaluation services”) are provided. The impact evaluation services allow prospective owners and operators of vehicles to receive detailed, customized information concerning a vehicle of interest before making a purchasing investment in the vehicle. In addition, the impact evaluation services enable consumers a one-stop source of information in which to compare multiple different vehicles across any participating vehicle brand. The impact evaluation services provide more than simple and generic EPA information (e.g., average city/highway miles per gallon); they provide information specific to each individual and his or her circumstances in a way that simulates actual ownership and operation of the vehicle of interest well before a purchasing decision is made. For example, a prospective buyer provides information about his/her typical commute or anticipated usage, as well as a vehicle of interest, and the impact evaluation services gathers information from a variety of different sources to calculate the estimated costs of ownership for this particular commute or usage. These costs are provided at a much more granular level than what is typically found, e.g., on an EPA sticker or vehicle manufacturer website.

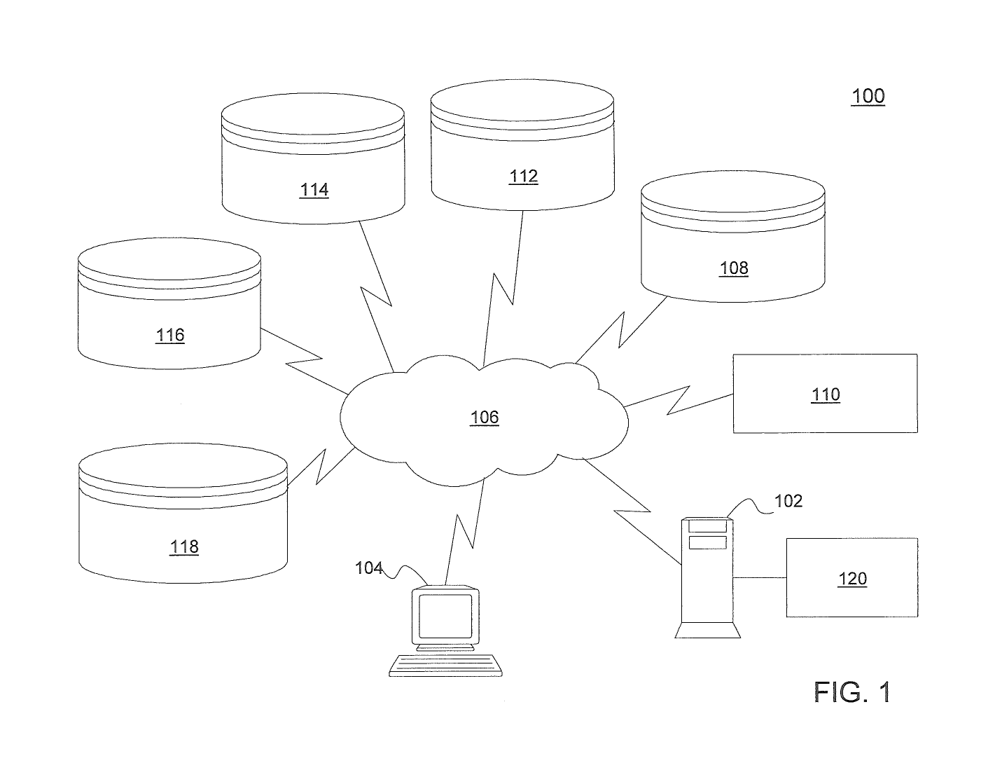

Turning now to FIG. 1, a system 100 upon which impact evaluation services may be implemented will now be described in an exemplary embodiment. The system 100 includes a host system 102 in communication with a user system 104 over one or more networks 106. The host system 102 is also in communication with network entities that include a vehicle specification database 108, a mapping engine and database 110, a topological map database 112, a climate database 114, an environmental database 116, and an electrical energy rate database 118 over the networks 106.

The host system 102 may be implemented by an enterprise or organization hosting the impact evaluation services and is configured with logic 120 for executing the impact evaluation services described herein. In one embodiment, the host system 102 is implemented by an application service provider (ASP) that engages with vehicle manufacturers and/or dealerships to provide the impact evaluation services to end users (e.g., vehicle consumers). In this embodiment, the manufacturer or dealership subscribes, or otherwise opts in, to the impact evaluation services, and the host system 102 enterprise includes the relevant vehicle brand in the impact evaluation services offered to end users. The host system 102 may be implemented as a high-speed computer processing device (e.g., a mainframe computer) capable of handling a high volume of activities conducted between the host system 102 and the network entities shown in FIG. 1.

The host system 102 may operate as a web server including a web site for generating subscription accounts for manufacturers and dealerships, as well as for providing access to impact evaluation services information to end users or consumers. The host system 102 may also operate as an application server including one or more applications for providing the impact evaluation services described herein. These one or more applications are collectively referred to herein as logic 120.

The networks 106 may be any type of known networks in the art. For example, the networks 106 may be a combination of public (e.g., Internet), private (e.g., local area network, wide area network, virtual private network), and may include wireless and wireline transmission systems (e.g., satellite, cellular network, terrestrial networks, etc.).

The user system 104 may be a computer processing device, such as a general-purpose desktop or laptop computer, or may be a portable device, such as a smart phone or personal digital assistant. The user system 104 may be implemented by a manufacturer or dealership in subscribing to the impact evaluation services as described above. The user system 104 may alternatively be implemented by an end user who is a prospective buyer of a vehicle (e.g., an end user of the impact evaluation services). It will be understood that while only a single user system 104 is shown in FIG. 1 for illustrative purposes, any number of user systems may be employed in realizing the advantages of the exemplary embodiments.

As indicated above, the host system 102 gathers data from a variety of network entities in order to facilitate the impact evaluation services. As shown in FIG. 1, the host system 102 may access the vehicle specification database 108 in order to acquire details about vehicles of interest to end users. The vehicle specification database 108 is shown for illustrative purposes as a single database. However, given the great number of various vehicle makes and models, the vehicle specification database 108 may be one of many such databases, each of which is organized to enable efficient access to vehicle data. In one embodiment, the vehicle specification database 108 is organized as a relational database in which vehicle data are classified by vehicle make, model and year. A unique vehicle identifier may be generated and stored in an index of identifiers to distinguish among each vehicle and to allow fast and efficient searching of the database 108. The vehicle specification database 108 stores capabilities and performance characteristics of each of the vehicle records or tables stored therein. For example, the capabilities and performance characteristics may include EPA fuel economy information, energy type (e.g., electric, gas, hybrid), transmission type (e.g., automatic, standard), fuel tank volume, capacity of battery pack, and various other available options. Fuel types may include fossil fuels, compressed natural gas, liquefied petroleum gas, ethanol, bio-diesel, etc.

The mapping engine and database 110 includes a mapping tool that takes as input a start address and an end address and returns as output one or more routes to follow for the addresses. The mapping engine and database 110 may include a database of maps for any region serviced by the engine. The mapping engine and database 110 may be a proprietary tool or a commercial application, such as Google Maps®. The impact evaluation services access the mapping engine and database 110 using information entered by the user system 104 and host system 102, as will be described further herein.

The topological map database 112 stores maps for any region serviced by the database 112 and provides terrain information such as elevation and gradations of terrain. The topological map database 112 may be operated as a proprietary tool or as a commercial application. The climate database 114 stores climatological data for any region serviced by the database 114 and provides average temperatures, average precipitation, and similar data for a region. The impact evaluation services access the topological map database 112 and the climate database 114 to retrieve terrain and climate data for a location or area defined by commute information provided by an end user of the impact evaluation services (e.g., the user system 104 and the host system 102). Climate and terrain can have a significant impact on a vehicle's performance in terms of energy consumed and environmental effects. The impact evaluation services utilize this information in assessing a vehicle's overall costs of ownership, as will be described further herein. While only a single topological map database 112 and a single climate database 114 are shown in FIG. 1, it will be understood that multiple such databases may be used and accessed in implementing the impact evaluation services.

The environmental database 116 stores environmental impact data in terms of emissions and energy expended by vehicles. For prospective buyers of vehicles, this information may be used in conjunction with other costs ownership in assisting the buyers with their purchasing decisions. For example, a vehicle with high emissions may lose out over a more costly vehicle that produces fewer emissions. The impact evaluation services access the environmental database 116 and use data entered by the user system 104 and host system 102 to derive the environmental impact data, as will be described further herein. While only a single environmental database 116 is shown for illustrative purposes, it will be understood that a number of databases storing environmental impact data may be employed. The environmental database 116 may be implemented by a government or consumer agency. Environmental impact data may also be derived for differing types of electric generation (e.g., coal, nuclear energy, natural gas, etc.) in order to determine emissions information resulting from the generation.

The electrical energy rate database 118 may be one of many different databases that provide energy information for specified regions. For example, the electrical energy rate database 118 may be implemented by an energy service provider that handles the delivery of electricity to customers within a given city, county, state, or other defined area. In one embodiment, the logic 120 accesses the electrical energy rate database 118 to determine a current rate of energy (in units) associated with commute information provided by a user. Alternatively, the user may supply this information to the logic via an interface of the impact evaluation services, as described further herein. As the costs of electricity vary from region to region, this information is useful in assessing the overall costs of ownership of a vehicle.

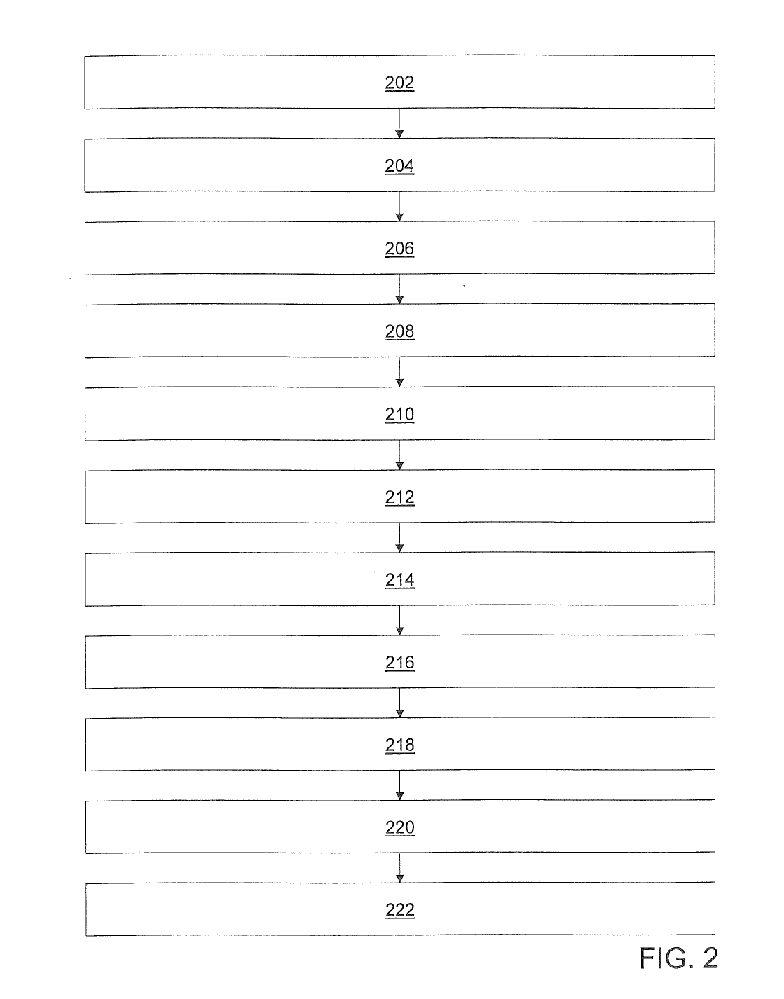

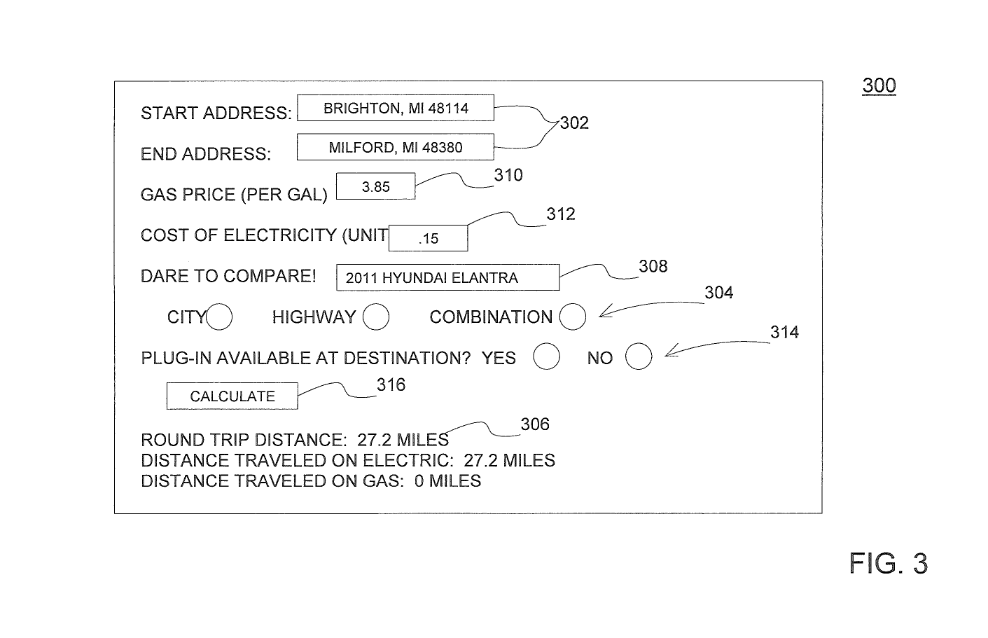

As indicated above, the impact evaluation services enable a service provider to offer detailed, customized information to prospective vehicle buyers concerning the costs of ownership. Turning now to FIGS. 2-4, a process for implementing the impact evaluation services and output produced by the impact evaluation services will now be described in an exemplary embodiment. The process described in FIG. 2 assumes that an end user has accessed a website provided by the host system 102 and is presented with a user interface prompting the end user through the process described herein. A sample user interface 300 is shown in FIG. 3.

At step 202, the host system 102 receives a commute type and commute data from the end user. As shown in FIG. 3, the user interface 300 provides an input field 304 for entering the commute type and an input field 302 for entering the commute data. Information regarding the commute type relates to the nature of the commute which affects the costs of ownership. Commute types may include city driving (which is known to lower the average miles per gallon of a vehicle), highway driving (which is known to increase the average miles per gallon of a vehicle), and a combination of city and highway driving. The commute type may additionally include a percentage of the commute that is city and a percentage of the commute that is highway. The impact evaluation services factor in the commute type to the assessment and evaluation of the costs of ownership, as described further herein. The commute data includes a starting address and an ending address of a typical commute of the end user.

At step 204, the logic 120 accesses the mapping engine and database 110, inputting the starting address and the ending address into the mapping engine. Alternatively, the mapping engine and database 110 may be incorporated or integrated with the logic 120 and the input addresses are directly entered into the engine. A mileage value 306 is calculated from the beginning and end addresses via the mapping engine and database 110. The mileage value 306 is a round trip number of miles spanning the commute.

At step 206, the logic 120 accesses the climate database 114 and uses the commute data and commute type to determine the climate for the area of commute. For example, the logic 120 inputs a zip code for the commute (e.g., the zip code of the starting address or ending address if the commute is within a specified number of miles) into the climate database 114 and the zip code, along with a date and time stamp of the request (i.e., user inputs to the web site) may be used to find the average climate for a time of year that is specified by the date and time stamp. For example, on January 13^{th} the end user accesses the host system 102 website and enters 48114 for a zip code. The logic 120 determines that the region is Brighton, Mich. (e.g., via the mapping engine and database 110), and the logic 120 determines from the date and time stamp that the time of year is winter. The climate database 114 reflects the average temperature in Brighton, Mich. for this time of year is 38 degrees. The impact evaluation services use this climate data, which may be adjusted based on topological data for the region identified by the commute data, as described next.

At step 208, the logic 120 accesses the topological map database 112 and uses the commute data and commute type to determine the terrain for the area of commute in a manner similar to that described above for the climate. For example, the logic 120 uses a zip code from the commute data to search the topological map database 112 for terrain information. It will be understood that multiple zip codes may be used in determining terrain (as well as climate) by determining a route specified for the commute and identifying intervening regions. Where one region in a commute has a high elevation and another region in the commute has a lower elevation, the impact evaluation services may be configured to calculate costs of ownership by apportioning its calculations over each of the segments of the commute.

At step 210, the logic 120 receives at least one vehicle identifier from the end user. In one embodiment, the logic 120 is configured to provide an option 308, such as a drop down list of participating vehicle makes and models that can be selected by the end user. The user may select more than one vehicle from the option 308 in order to compare costs.

At step 212, the logic 120 receives from the end user the gas price per gallon for the region of commute via an input field 310. In addition, the logic 120 may receive from the end user the current cost of electricity 312 (in units) for the region of the commute. Alternatively, the gas and/or electricity prices may be acquired by the logic 120 using the commute data (e.g., address information) to determine the costs of gas and/or electricity local to that area, e.g., by retrieving average gas/electrical prices from external sources.

Other information may be provided by the end user, such as an indicator of whether a plug-in is available at the commute destination for charging the vehicle. This information may be provided via an input field 314 of the user interface 300. Using an example in which the commute is directed to the end user's daily work commute, the end user may utilize a plug-in (if available) at the end user's work location to increase the usable electric vehicle range of the commute. By charging the vehicle at work, the end user is provided with additional available electric capacity for the drive home (e.g., as compared to using gasoline or other fuel source). For example, if the end user has a 20 mile total (round trip) commute but has only 10 miles of electric vehicle range, the end user may remain entirely in electric mode by charging the vehicle at work.

The end user selects an option 316 once all information has been entered. Selection of this option causes the logic 120 to perform additional functions before calculating the costs of ownership, as will now be described.

At step 214, the logic 120 accesses the vehicle specification database 108 and retrieves vehicle specification data for the vehicle identifier(s) derived from the vehicle selection(s) entered by the end user in input field 308.

At step 216, the logic 120 accesses environmental impact data for the selected vehicles, e.g., emissions data and energy expended from the environmental database 116.

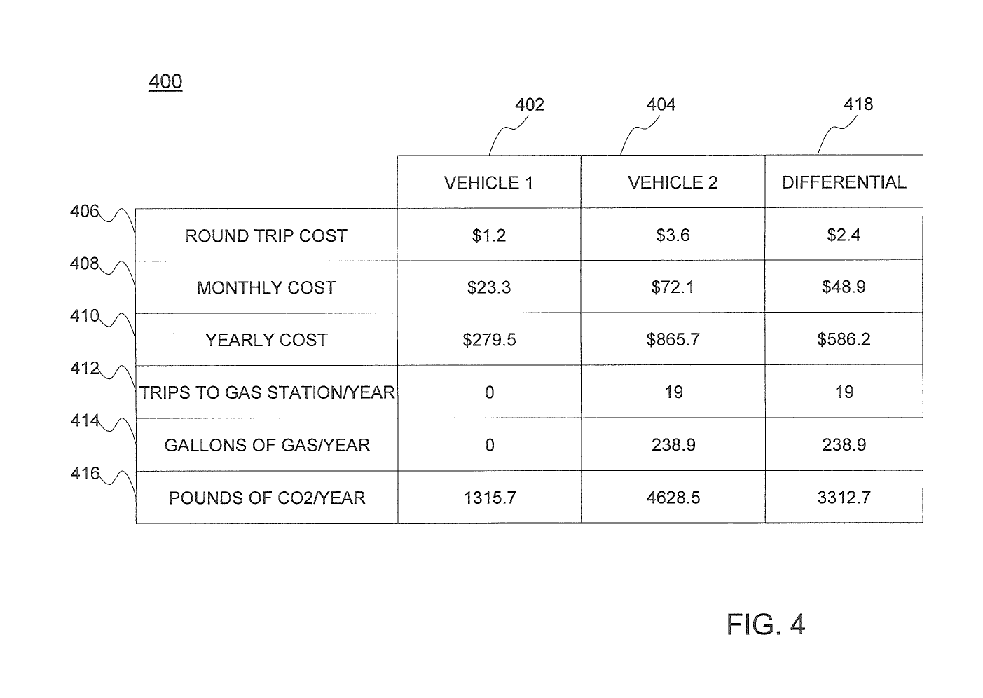

At step 218, the logic 120 applies the vehicle specification data to the mileage, commute type, climate data, terrain, gas (fuel) and electric prices, and environmental data. The logic 120 calculates costs of ownership for the selected vehicle and/or costs of ownership and differentials when more than one vehicle is selected at step 220. At step 222, the output of the calculations is presented to the end user in a table form. As shown in FIG. 4, two vehicles were selected by the end user, and the costs of ownership are presented in terms of round trip costs of fuel, monthly costs, yearly costs, trips to gas station per year, gallons of gas or fuel consumed per year, and pounds of CO2 generated.

The logic 120 may be configured to calculate the costs of ownership using various techniques. In one embodiment, the logic 120 calculates a cost for a given commute in terms of energy expended using mileage information, local energy prices, and vehicle specification data. This baseline cost is then adjusted higher or lower based on climate data and terrain data using information from topological map database 112 and climate database 114. For example, varying levels or gradations of terrain denoted for a particular commute may be given weights commensurate with the corresponding gradations, such that the greater the angle of incline in a terrain over a defined distance, the lower the miles per gallon estimate will be (or a higher consumption of electrical power); thus, the weights applied to the baseline cost are revised to reflect the additional consumption of fuel or energy. Likewise, the warmer or colder a climate is, the more energy is typically consumed by a vehicle in terms of heating, ventilation, and air conditioning systems used. Accordingly, the baseline costs may further be adjusted to factor in these elements. The environmental impact information may be used as another tool in enabling an end user to assess the overall costs of ownership in terms of environmental impact attributed to the vehicle usage. End users who are environmentally conscious may desire this information as one of the factors used in selecting a vehicle.

A table 400 is shown in FIG. 4, which illustrates sample output values provided by the impact evaluation services once the calculations have been performed. As shown in FIG. 4, by way of a non-limiting example, two vehicles are provided in respective columns 402 and 404. For each vehicle, the logic 120 calculates costs of ownership for a given commute that include round trip costs in row 406, monthly costs in row 408, and yearly costs in row 410. Additionally, for each vehicle, the logic 120 calculates a number of trips to the gas station per year for the commute in row 412, the number of gallons of gas consumed per year in row 414, and the number of pounds of CO2 estimated for the commute in row 416. In column 418, the logic presents a differential value reflecting the differences in these costs between the two vehicles under comparison.

In an embodiment, the output values may also include data relating to a return on investment for each of the vehicles examined. For example, the logic 120 may be configured to utilize the estimated costs of ownership (including the commute data) in conjunction with the base price of the vehicles to evaluate any relative gains and/or losses that may be useful in assessing whether the purchase will be a desirable investment.

The steps described above in FIG. 2 may be presented out of order, and a number of the steps may be omitted as desired.

Technical effects include impact evaluation services website in which prospective owners of vehicles can receive detailed, customized information concerning a vehicle of interest before making a purchasing investment in the vehicle. In addition, the impact evaluation services enable consumers a one-stop source of information in which to compare multiple different vehicles across any participating vehicle brand. The impact evaluation services provide information specific to each individual and his or her circumstances in a way that simulates actual ownership and operation of the vehicle of interest well before a purchasing decision is made. For example, a prospective buyer provides information about his/her typical commute or anticipated usage, as well as a vehicle of interest, and the impact evaluation services gathers information from a variety of different sources to calculate the estimated costs of ownership for this particular commute or usage. These costs are provided at a much more granular level than what is typically found, e.g., on an EPA sticker or vehicle manufacturer website.

As described above, the invention may be embodied in the form of computer implemented processes and apparatuses for practicing those processes. Embodiments of the invention may also be embodied in the form of computer program code containing instructions embodied in tangible media, such as floppy diskettes, CD-ROMs, hard drives, or any other computer readable storage medium, wherein, when the computer program code is loaded into and executed by a computer, the computer becomes an apparatus for practicing the invention. An embodiment of the invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the present application.

What is claimed is:

1. A system for implementing vehicle ownership impact evaluation services, the system comprising:
a host system computer; and
logic executable by the host system computer, the logic configured to implement a method, the method comprising:
calculating a mileage value indicative of a round trip for a commute using a start address and an end address that are received from a user, the start address and the end address collectively specifying commute data for the commute;
accessing a database containing topographical information using routing information derived from the commute data, and acquiring terrain data for the commute;
using the routing information in conjunction with a timestamp associated with input received from the user, accessing a database containing climate information for a geography identified from the routing information, and determining an estimated climate for a time of year via the timestamp;
receiving, from the user, an identifier for a first vehicle;
accessing a specification database and retrieving specification data for the first vehicle via the identifier, the specification data including capabilities, performance characteristics, and specifications of the first vehicle;
applying the specification data for the first vehicle to the mileage value, the estimated climate, the terrain data, and a base energy price; and
calculating estimated costs for the commute in terms of energy consumed for the round trip by the first vehicle, the estimated costs being a function of the mileage, the estimated climate, the terrain data, and the base energy price.

2. The system of claim 1, wherein the logic is further configured to implement:
receiving, from the user, a second identifier for a second vehicle, wherein accessing the specification database further includes retrieving specification data for the second vehicle via the second identifier;
applying the specification data for the second vehicle to the mileage value, the estimated climate, the terrain data, and the base energy price;
calculating estimated costs for the commute in terms of energy consumed for the round trip by the second vehicle, the estimated costs associated with the second vehicle being a function of the mileage, the estimated climate, the terrain data, and the base energy price; and
outputting the estimated costs calculated for the commute for both of the first vehicle and the second vehicle, the estimated costs differentiated within a table with respect to the first vehicle and the second vehicle.

3. The system of claim 1, wherein the logic is further configured to implement:
receiving commute type data for a commute type of the commute, the commute type including city driving, highway driving, and combined city and highway driving; and
applying the specification data for the first vehicle to the commute type data;
wherein calculating the estimated costs of the commute in terms of energy consumed for the round trip by the first vehicle includes factoring in the commute type data, the estimated costs further being a function of the commute type.

4. The system of claim 1, wherein the logic is further configured to implement:
receiving the base energy price, the base energy price specific to the geography identified from the routing information.

5. The system of claim 1, wherein determining the estimated climate for a time of year is implemented using a date associated with the time stamp that is derived from the input received from the user.

6. The system of claim 1, wherein the logic is further configured to implement:
retrieving environmental data for the first vehicle from a database containing environmental impact data, the environmental data including emissions data;
wherein calculating the estimated costs for the commute includes determining an estimated amount of emissions produced by implementing the commute via the first vehicle.

7. The system of claim 1, wherein calculating the estimated costs of the commute for the round trip further includes determining the base energy price for the geography identified from the routing information, the base energy price attributed to at least one of electric energy sources, fossil fuel energy sources, and hybrid energy sources.

8. The system of claim 1, wherein the logic is further configured to implement:
calculating additional costs using the estimated costs for the commute as a base value, the calculating additional costs including determining accrued costs of multiple round trips over a defined period of time; and
outputting the estimated costs calculated for the commute within a table, the estimated costs including the additional costs.

9. A method for implementing vehicle ownership impact evaluation services, the method comprising:
calculating a mileage value indicative of a round trip for a commute using a start address and an end address that are received from a user, the start address and the end address collectively specifying commute data for the commute;
accessing a database containing topographical information using routing information derived from the commute data, and acquiring terrain data for the commute;
using the routing information in conjunction with a timestamp associated with input received from the user, accessing a database containing climate information for a geography identified from the routing information, and determining an estimated climate for a time of year via the timestamp;
receiving, from the user, an identifier for a first vehicle;
accessing a specification database and retrieving specification data for the first vehicle via the identifier, the specification data including capabilities, performance characteristics, and specifications of the first vehicle;
applying the specification data for the first vehicle to the mileage value, the estimated climate, the terrain data, and a base energy price; and
calculating estimated costs for the commute in terms of energy consumed for the round trip by the first vehicle, the estimated costs being a function of the mileage, the estimated climate, the terrain data, and the base energy price.

10. The method of claim 9, further comprising:
receiving, from the user, a second identifier for a second vehicle, wherein accessing the specification database further includes retrieving specification data for the second vehicle via the second identifier;
applying the specification data for the second vehicle to the mileage value, the estimated climate, the terrain data, and the base energy price;
calculating estimated costs for the commute in terms of energy consumed for the round trip by the second vehicle, the estimated costs associated with the second vehicle being a function of the mileage, the estimated climate, the terrain data, and the base energy price; and
outputting the estimated costs calculated for the commute for both of the first vehicle and the second vehicle, the estimated costs differentiated within a table with respect to the first vehicle and the second vehicle.

11. The method of claim 1, further comprising:
receiving commute type data for a commute type of the commute, the commute type including city driving, highway driving, and combined city and highway driving; and
applying the specification data for the first vehicle to the commute type data;
wherein calculating the estimated costs of the commute in terms of energy consumed for the round trip by the first vehicle includes factoring in the commute type data, the estimated costs further being a function of the commute type.

12. The method of claim 1, further comprising:
receiving the base energy price, the base energy price specific to the geography identified from the routing information.

13. The method of claim 9, wherein determining the estimated climate for a time of year is implemented using a date associated with the time stamp that is derived from the input received from the user.

14. The method of claim 9, further comprising:
retrieving environmental data for the first vehicle from a database containing environmental impact data, the environmental data including emissions data;
wherein calculating the estimated costs for the commute includes determining an estimated amount of emissions produced by implementing the commute via the first vehicle.

15. The method of claim 9, wherein calculating the estimated costs of the commute for the round trip further includes determining the base energy price for the geography identified from the routing information, the base energy price attributed to at least one of electric energy sources, fossil fuel energy sources, and hybrid energy sources.

16. The method of claim 9, further comprising:
calculating additional costs using the estimated costs for the commute as a base value, the calculating additional costs including determining accrued costs of multiple round trips over a defined period of time; and
outputting the estimated costs calculated for the commute within a table, the estimated costs including the additional costs.

17. A computer program product implementing vehicle ownership impact evaluation services, the computer program product comprising a computer-readable storage medium encoded with instructions, which when executed by a computer cause the computer to implement a method, the method comprising:
receiving, from the user, a second identifier for a second vehicle, wherein accessing the specification database further includes retrieving specification data for the second vehicle via the second identifier;
applying the specification data for the second vehicle to the mileage value, the estimated climate, the terrain data, and the base energy price;
calculating estimated costs for the commute in terms of energy consumed for the round trip by the second vehicle, the estimated costs associated with the second vehicle being a function of the mileage, the estimated climate, the terrain data, and the base energy price; and
outputting the estimated costs calculated for the commute for both of the first vehicle and the second vehicle, the estimated costs differentiated within a table with respect to the first vehicle and the second vehicle.

18. The computer program product of claim 17, further comprising instructions for implementing:
receiving commute type data for a commute type of the commute, the commute type including city driving, highway driving, and combined city and highway driving; and
applying the specification data for the first vehicle to the commute type data;
wherein calculating the estimated costs of the commute in terms of energy consumed for the round trip by the first vehicle includes factoring in the commute type data, the estimated costs further being a function of the commute type.

19. The computer program product of claim 17, further comprising instructions for implementing:
receiving the base energy price, the base energy price specific to the geography identified from the routing information.

20. The computer program product of claim 17, wherein determining the estimated climate for a time of year is implemented using a date associated with the time stamp that is derived from the input received from the user.
